(19) United States
(12) Patent Application Publication
(10) Pub. No.: US 2013/0324629 A1
(43) Pub. Date: Dec. 5, 2013

(54) RESIN FOAM AND PROCESS FOR PRODUCING THE SAME

(71) Applicants: Mitsuhiro Kanada, Ibaraki-shi (JP); Takayuki Yamamoto, Ibaraki-shi (JP); Mie Ota, Ibaraki-shi (JP); Yoshinori Kouno, Ibaraki-shi (JP); Hironori Yasuda, Ibaraki-shi (JP); Yuko Kandori, Ibaraki-shi (JP); Kei Yoshida, Ibaraki-shi (JP)

(72) Inventors: Mitsuhiro Kanada, Ibaraki-shi (JP); Takayuki Yamamoto, Ibaraki-shi (JP); Mie Ota, Ibaraki-shi (JP); Yoshinori Kouno, Ibaraki-shi (JP); Hironori Yasuda, Ibaraki-shi (JP); Yuko Kandori, Ibaraki-shi (JP); Kei Yoshida, Ibaraki-shi (JP)

(73) Assignee: NITTO DENKO CORPROATION, Ibaraki-shi, Osaka (JP)

(21) Appl. No.: 14/000,161

(22) PCT Filed: Feb. 2, 2012
(86) PCT No.: PCT/JP2012/052355

§ 371 Date: Aug. 16, 2013

(30) Foreign Application Priority Data
Feb. 17, 2011 (JP) 2011-031907
Jan. 27, 2012 (JP) 2012-014781

(51) Int. Cl. C08F 220/46; C08J 9/12

(52) U.S. Cl. CPC C08F 220/46; C08J 9/122
USPC 521/149; 264/419

(57) ABSTRACT

Provided is a resin foam which has satisfactory strain recovery, is particularly resistant to shrinkage of its cell structure caused by the resinous restitutive force at high temperatures, and exhibits superior high-temperature strain recovery. The resin foam according to the present invention is obtained from a resin composition including an elastomer and an active-energy-ray-curable compound. The resin composition gives an unfoamed measurement sample having a glass transition temperature of 30° C. or lower and a storage elastic modulus (E′) at 20° C. of 1.0×10⁷ Pa or more, each determined by a dynamic viscoelastic measurement.

### TECHNICAL FIELD

The present invention relates to resin foams excellent in cushioning properties and strain recovery (compression set recovery); and to processes for producing the resin foams. Specifically, the present invention relates to a resin foam and a production process thereof, which resin foam has satisfactory cushioning properties and exhibits superior high-temperature strain recovery. The resin foam is extremely useful typically as internal insulators in electronic devices, cushioning materials, sound insulators, heat insulators, food packaging materials, clothing materials, and building materials.

### BACKGROUND ART

Some foams have been used typically as internal insulators in electronic devices, cushioning materials, sound insulators, heat insulators, food packaging materials, clothing materials, and building materials. To surely have sealability upon integration as components, the foams should excel in properties such as flexibility, cushioning properties, and heat insulating properties. In the uses, thermoplastic resin foams are well known to be used. The thermoplastic resin foams are represented by foams of polyolefins such as polyethylenes and polypropylenes. The thermoplastic resin foams are those derived from thermoplastic resins that do not have rubber elasticity at room temperature. These foams, however, disadvantageously have low strengths and are insufficient in flexibility and cushioning properties. In particular, when held under compression at high temperatures, they have poor strain recovery and exhibit insufficient sealability. An attempt has been made to improve the disadvantages by incorporating, for example, a rubber component (elastomer component) into a thermoplastic resin to impart elasticity to the resin. This allows the material resin itself to become soft (flexible) and to exhibit restitution due to the elasticity to thereby have improved strain recovery. Though the incorporated elastomer component generally improves the restitution due to elasticity, the resulting foam shows a low expansion ratio. This is because, once the resin undergoes expansion and deformation by the action of a blowing agent to form a cell structure in a foam production process, the cell structure thereafter shrinks due to the restitutive force (resilience) of the resin.

Customary processes for the production of foams generally include chemical processes and physical processes. A common physical process involves dispersing a low-boiling liquid (blowing agent), such as a chlorofluorocarbon or a hydrocarbon, in a polymer and then heating the dispersion to volatilize the blowing agent to thereby form cells (bubbles). A chemical process for obtaining a foam involves adding a compound (blowing agent) to a polymer base and thermally decomposing the compound to evolve a gas to thereby form cells. However, the physical foaming technique causes various environmental disadvantages such that the substance to be used as the blowing agent may be harmful and may deplete ozonosphere. The chemical foaming technique disadvantageously suffers from contamination of a corrosive gas and impurities remaining in the foam after expansion; but such contamination is undesirable particularly in electronic components and other applications where the contamination should be minimized or prevented.

A process for obtaining a foam having a small cell diameter and a high cell number has been recently proposed. This process involves dissolving a gas such as nitrogen or carbon dioxide in a polymer under a high pressure, subsequently releasing the polymer from the pressure, and heating up the polymer to the vicinity of the glass transition temperature or softening point thereof to form cells. In a foaming technique of this type, a gas such as nitrogen or carbon dioxide is dissolved in a polymer under a high pressure, the polymer is then released from the pressure and, in some cases, is heated to a temperature around the glass transition temperature to allow cell expansion and growth. The foaming technique advantageously gives a foam having such fine cells than ever. In the foaming technique, nuclei are formed from a thermodynamically unstable state and expand and grow to form cells and thereby give a micro-cellular (microporous) foam. Various attempts to apply the foaming technique to thermoplastic polyurethanes and other thermoplastic elastomers have been proposed in order to give soft foams. Typically, a process is known in which a thermoplastic polyurethane resin is expanded by the foaming technique to give a foam having uniform and fine cells and being resistant to deformation (see Patent Literature (PTL) 1).

The process, however, disadvantageously fails to provide a foam with a sufficient expansion ratio. Specifically, after the release of pressure (decompression) to reach an atmospheric pressure, nuclei formed by the gas (e.g., nitrogen or carbon dioxide), which has been dissolved in the polymer, expand and grow to form cells, and a foam with a high expansion ratio is once formed. However, the gas (e.g., nitrogen or carbon dioxide) remained in the cells gradually passes through the polymer cell walls, and the polymer cells shrink after expansion. The cells thereby gradually deform and/or shrink to fail to maintain the initial high expansion ratio.

As a possible solution to this disadvantage, there has been proposed a process in which a thermoplastic resin composition containing an ultraviolet-curable resin is prepared as a material, the resin composition is expanded, and subsequently the ultraviolet-curable resin is cured by a crosslinked structure to form a resin foam (see PTL 2). However, the resin foam obtained by the process may undergo deformation of the resin (deformation of the material), and the deformation may be fixed during evaluation or usage, when performed at a temperature near to the glass transition temperature of the constitutive resin. To prevent this, demands have been made to provide a resin foam having better strain recovery (particularly better high-temperature strain recovery).

The thermoplastic resin foams derived from the thermoplastic polyurethanes or thermoplastic elastomers have restrictions due to their heat-resistant temperatures and may apprehensively fail to exhibit sufficient recovery due to material plasticization and/or suffer from thermal deterioration in a temperature range of 80° C. or higher.

### CITATION LIST

### Patent Literature

PTL 1: Japanese Unexamined Patent Application Publication (JP-A) No. H10-168215
PTL 2: JP-A No. 2009-13397

### SUMMARY OF INVENTION

### Technical Problem

Accordingly, an object of the present invention is to provide a resin foam which has satisfactory strain recovery, is particularly resistant to cell-structure shrinkage due to the resinous restitutive force at high temperatures, and exhibits superior high-temperature strain recovery.

Another object of the present invention is to provide a resin foam which has satisfactory strain recovery, particularly superior high-temperature strain recovery, and exhibits strength, flexibility, and cushioning properties at satisfactory levels.

### Solution to Problem

After intensive investigations to achieve the objects, the present inventors have found that a resin foam obtained from a resin composition including an elastomer and an active-energy-ray-curable compound, when allowed to have a glass transition temperature of 30° C. or lower and a storage elastic modulus (E′) at 20° C. of 1.0×10⁷ Pa or more, can be shaped without cell structure shrinkage and can have better strain recovery, particularly better high-temperature strain recovery. The present invention has been made based on these findings.

Specifically, the present invention provides a resin foam obtained from a resin composition comprising an elastomer and an active-energy-ray-curable compound, in which the resin composition gives an unfoamed measurement sample having a glass transition temperature of 30° C. or lower and a storage elastic modulus (E′) at 20° C. of 1.0×10⁷ Pa or more, each as determined by a dynamic viscoelastic measurement.

In a preferred embodiment of the resin foam according to the present invention, the elastomer has a glass transition temperature of 30° C. or lower; and the resin composition, when cured under a specific curing condition, has a glass transition temperature of 30° C. or lower, the curing condition expressed as follows:

Curing condition: the resin composition is cured by molding the resin composition into a sheet having a thickness of 0.3 mm to give a resin molded article; irradiating the resin molded article with an electron beam at an acceleration voltage of 250 kV to a dose of 200 kGy; and leaving the irradiated article stand at an ambient temperature of 170° C. for one hour.

In another preferred embodiment, the resin foam according to the present invention is obtained by subjecting the resin composition to expansion molding to give a foamed structure; and irradiating the foamed structure with an active energy ray.

In yet another preferred embodiment, the expansion molding of the resin composition is performed by impregnating the resin composition with a blowing agent and decompressing the impregnated resin composition to expand the resin composition.

In a preferred embodiment, carbon dioxide or nitrogen is used as the blowing agent in the expansion molding of the resin composition.

In another preferred embodiment, liquefied carbon dioxide is used as the blowing agent in the expansion molding of the resin composition.

In yet another preferred embodiment, carbon dioxide in a supercritical state is used as the blowing agent in the expansion molding of the resin composition.

In still another preferred embodiment, the resin foam according to the present invention has a strain recovery rate (80° C., 50% compression set) of 40% or more.

In another preferred embodiment, the resin foam according to the present invention has an expansion ratio of 5 times or more.

In addition and advantageously, the present invention provide a process for producing a resin foam. The process includes the steps of: (1) subjecting a resin composition to expansion molding to form a foamed structure, the resin composition comprising an elastomer and an active-energy-ray-curable compound; and (2) irradiating the foamed structure with an active energy ray, in which the process further includes the step of preparing, as the resin composition, a resin composition that gives an unfoamed measurement sample having a glass transition temperature of 30° C. or lower and a storage elastic modulus (E′) at 20° C. of 1.0×10⁷ Pa or more, each as determined by a dynamic viscoelastic measurement.

### Advantageous Effects of Invention

The resin foam according to the present invention has the configuration as above, thereby exhibits satisfactory strain recovery, is particularly resistant to cell structure shrinkage due to resinous restitutive force at high temperatures, and exhibits superior high-temperature strain recovery.

The process for producing a resin foam according to the present invention is advantageous for the efficient production of a resin foam that exhibits satisfactory strain recovery, is particularly resistant to cell structure shrinkage due to resinous restitutive force at high temperatures, and exhibits superior high-temperature strain recovery.

### BRIEF DESCRIPTION OF DRAWINGS

FIG. 1 is a schematic cross-sectional view illustrating a first embodiment of a foam laminate including a resin foam according to the present invention in combination with a surface layer.

FIG. 2 is a schematic cross-sectional view illustrating a second embodiment of a foam laminate including a resin foam according to the present invention in combination with a surface layer.

FIG. 3 is a schematic cross-sectional view illustrating a third embodiment of a foam laminate including a resin foam according to the present invention in combination with a surface layer.

FIG. 4 is a schematic cross-sectional view illustrating a fourth embodiment of a foam laminate including a resin foam according to the present invention in combination with a surface layer.

FIG. 5 is a schematic cross-sectional view illustrating a fifth embodiment of a foam laminate including a resin foam according to the present invention in combination with a surface layer.

### DESCRIPTION OF EMBODIMENTS

A resin foam according to an embodiment of the present invention is obtained from a resin composition including an elastomer and an active-energy-ray-curable compound. The “resin composition including an elastomer and an active-energy-ray-curable compound” is hereinafter also simply referred to as a “resin composition”.

Specifically, the resin foam according to the present invention is obtained by expanding and molding the resin composition and is preferably obtained by subjecting the resin composition to expansion molding to give a foamed structure, and irradiating the foamed structure with an active energy ray.

The resin foam according to the present invention has a glass transition temperature of 30° C. or lower (e.g., from −40° C. to 30° C.), and more preferably 20° C. or lower (e.g., from −30° C. to 20° C.). The resin foam according to the present invention has a glass transition temperature of 30° C. or lower, which glass transition temperature is equal to or lower than a service temperature (e.g., from about 30° C. to about 80° C.) in an actual-use environment. The resin foam, even when it deforms, maintains the stress without relaxation and can therefore exhibit satisfactory strain recovery even in a high-temperature environment at a temperature higher than room temperature. As used herein the term “high temperature(s)” refers to a temperature of from 40° C. to 120° C., and particularly refers to a temperature of from 50° C. to 80° C.

When the resin foam has two or more glass transition temperatures, a highest one is defined as the glass transition temperature of the resin foam.

The glass transition temperature is determined by a dynamic viscoelastic measurement of an unfoamed measurement sample. The unfoamed measurement sample is obtained by molding the resin composition into a sheet having a thickness of 0.3 mm to give a resin molded article; irradiating the resin molded article with an electron beam to a dose of 200 kGy; and leaving the irradiated resin molded article stand at an ambient temperature of 170° C. for one hour. A loss elastic modulus E″ of the unfoamed measurement sample is determined by a dynamic viscoelastic measurement, whose peak temperature is defined as the glass transition temperature.

The resin foam according to the present invention has a storage elastic modulus (E′) at 20° C. of 1.0×10⁷ Pa or more (e.g., from 1.0×10⁷ Pa to 1.0×10⁹ Pa) and more preferably 2.0×10⁷ Pa or more (e.g., from 2.0×10⁷ Pa to 5.0×10⁸ Pa).

The storage elastic modulus (E′) at 20° C. of the resin foam according to the present invention is determined by a dynamic viscoelastic measurement of an unfoamed measurement sample. The unfoamed measurement sample is the same as with the unfoamed measurement sample for the determination of the glass transition temperature of the resin foam.

The storage elastic modulus (E′) at 20° C. can also be determined by molding the resin foam into a sheet having a thickness of 0.3 mm as an unfoamed measurement sample; and performing a dynamic viscoelastic measurement on the unfoamed measurement sample.

Though not critical, the resin foam according to the present invention has an expansion ratio of preferably 5 times or more (e.g., from 5 to 60 times) and more particularly preferably 6 times or more (e.g., from 6 to 40 times). The resin foam, if having an expansion ratio of less than 5 times, may disadvantageously suffer from insufficient flexibility and/or cushioning properties.

The expansion ratio of the resin foam according to the present invention may be determined according to the following expression:

Expansion ratio(time)=(Density before expansion)/(Density after expansion)

The density before expansion refers typically to the density of the material resin composition. The density after expansion refers to the density of the resulting resin foam.

The resin foam according to the present invention has a strain recovery rate (80° C., 50% compression set) of preferably, but not critically, 40% or more (e.g., from 40% to 100%) and more preferably 45% or more (e.g., from 45% to 95%). The resin foam, if having a strain recovery rate (80° C., 50% compression set) of less than 40%, may suffer from poor strain recovery after being held under compression at high temperatures and suffer from poor sealability at high temperatures.

The strain recovery rate (80° C., 50% compression set) may be determined in the following manner. Initially, the resin foam as a specimen is compressed to a thickness 50% of the initial thickness and stored as intact (under compression) at 80° C. for 24 hours. Twenty-four (24) hours later, the specimen is returned to room temperature while maintaining the compression, followed by decompression. Twenty-four (24) hours after the decompression, the thickness of the specimen is measured. The ratio of the recovered distance to the compressed distance is defined as the strain recovery rate (80° C., 50% compression set).

The shape, thickness, and other dimensions of the resin foam according to the present invention are not critical and can be suitably selected according typically to the intended use. The resin foam may be in the form typically of a sheet, tape, or film. The resin foam, typically when in a sheet form, may have a thickness of preferably from 0.1 to 20 mm and more preferably from 0.2 to 15 mm.

Though not limited, the resin foam according to the present invention preferably has a closed cell structure or a semi-open/semi-closed cell structure as its cell structure. The “semi-open/semi-closed cell structure” refers to a cell structure including both a closed cell structure and an open cell structure.

The resin foam according to the present invention is specifically obtained by expanding and molding a resin composition including an elastomer and an active-energy-ray-curable compound; and is preferably obtained by subjecting the resin composition to expansion molding and further irradiating the resulting article with an active energy ray, as described above. The resin foam according to the present invention is more preferably obtained by subjecting the resin composition to expansion molding; and further subjecting the resulting article to both active energy ray irradiation and heating. The article, when subjected to both active energy ray irradiation and heating, is preferably subjected to active energy ray irradiation and to heating in this order, though the order is not limited.

The resin foam according to the present invention has flexibility and cushioning properties at satisfactory levels because of being formed from a material resin composition including an elastomer. The elastomer (thermoplastic resin or thermoplastic elastomer) is not limited, as long as having rubber elasticity at room temperature, but is exemplified by acrylic elastomers, urethane elastomers, styrenic elastomers, polyester elastomers, polyamide elastomers, and polyolefin elastomers. Among them, the elastomer is preferably an acrylic elastomer. This is because such an acrylic elastomer can be easily designed to have a desired glass transition temperature and a desired elastic modulus and can easily have arbitrary crosslinking points as introduced, owing to molecular structures of constitutive monomers. The resin composition may include one elastomer alone or two or more different elastomers.

The resin composition preferably includes the elastomer as a principal component. The resin composition may contain the elastomer in a content of typically preferably 30 percent by weight or more (e.g., from 30 to 70 percent by weight), more preferably 35 percent by weight or more (e.g., from 35 to 70 percent by weight), and particularly preferably 40 percent by weight or more (e.g., from 40 to 70 percent by weight), based on the total weight of the resin composition. The resin composition, if containing the elastomer in a content of less than 30 percent by weight, may have a lower viscosity and exhibit insufficient expanding ability (foamability). The resin composition, if containing the elastomer in a content of more than 70 percent by weight, may have an excessively high viscosity in some formulations, and this may impede, for example, extrusion operation of the resin composition to adversely affect the workability upon production of the resin foam.

The acrylic elastomer is an acrylic polymer (homopolymer or copolymer) obtained from at least one acrylic monomer employed as a monomer component.

The acrylic monomer is preferably an acrylic alkyl ester having a straight or branched chain alkyl moiety. The acrylic alkyl ester is exemplified by ethyl acrylate (EA), butyl acrylate (BA), 2-ethylhexyl acrylate (2-EHA), isooctyl acrylate, isononyl acrylate, propyl acrylate, isobutyl acrylate, and hexyl acrylate. Among them, butyl acrylate (BA) is preferred. Each of different acrylic alkyl esters may be used alone or in combination.

The acrylic monomer (particularly, the acrylic alkyl ester) is used as a principal monomer component to form the acrylic elastomer, and a content thereof is typically preferably 50 percent by weight or more and more preferably 70 percent by weight or more, based on the total weight of entire monomer components constituting the acrylic elastomer.

The acrylic elastomer, when being a copolymer, may employ a monomer component copolymerizable with the acrylic alkyl ester as appropriate. The “monomer component copolymerizable with the acrylic alkyl ester” is also referred to as an “other monomer component”. Such other monomer components may be used alone or in combination.

The other monomer component is preferably a functional-group-containing monomer. The term “functional-group-containing monomer” refers to a monomer which serves as a monomer component constituting an elastomer and, when the elastomer is obtained by copolymerization of the monomer with a principal monomer component, which provides a functional group capable of reacting with the functional group of a thermal crosslinking agent in the elastomer. The thermal crosslinking agent will be mentioned later. As used herein the “functional group contained in the elastomer and capable of reacting with a functional group of the thermal crosslinking agent” is also referred to as a “reactive functional group”.

The functional-group-containing monomer, when used as the other monomer component, gives an acrylic elastomer having a reactive functional group. The resin foam according to the present invention, in which a crosslinked structure is to be formed by the action of the thermal crosslinking agent, preferably employs an acrylic elastomer having a reactive functional group as the elastomer.

The functional-group-containing monomer is exemplified by carboxyl-containing monomers such as methacrylic acid (MAA), acrylic acid (AA), and itaconic acid (IA); hydroxyl-containing monomers such as hydroxyethyl methacrylate (HEMA), 4-hydroxybutyl acrylate (4HBA), and hydroxypropyl methacrylate (HPMA); amino-containing monomers such as dimethylaminoethyl methacrylate (DM); amido-containing monomers such as acrylamide (AM) and methylolacrylamide (N-MAN); epoxy-containing monomers such as glycidyl methacrylate (GMA); acid anhydride-containing monomers such as maleic anhydride; and cyano-containing monomers such as acrylonitrile (AN). Among them, carboxyl-containing monomers such as methacrylic acid (MAA) and acrylic acid (AA); hydroxyl-containing monomers such as 4-hydroxybutyl acrylate (4HBA); and cyano-containing monomers such as acrylonitrile (AN) are preferred for easiness in crosslinking, of which acrylic acid (AA), 4-hydroxybutyl acrylate (4HBA), and acrylonitrile (AN) are more preferred.

The functional-group-containing monomer may be used in a content of typically preferably from 1 to 30 percent by weight and more preferably from 1 to 20 percent by weight, based on the total weight of entire monomer components constituting the acrylic elastomer. The functional-group-containing monomer, if used in a content of more than 20 percent by weight, may impede the synthetic preparation of the acrylic elastomer; and, if used in a content of less than 1 percent by weight, may cause a low crosslinking density and fail to exhibit sufficient crosslinking effects in the foam.

Of monomer components to form the acrylic elastomer, other monomer components (comonomers) than the functional-group-containing monomer are exemplified by vinyl acetate (VAc), styrene (St), methyl methacrylate (MMA), methyl acrylate (MA), and methoxyethyl acrylate (MEA); as well as acrylic alkyl esters having a cyclic alkyl moiety, such as isobornyl acrylate (IBXA). Among them, methoxyethyl acrylate (MEA) is preferred for resistance at low temperatures.

The comonomer may be used in a content of typically preferably from 0 to 50 percent by weight and more preferably from 0 to 30 percent by weight, based on the total weight of entire monomer components constituting the acrylic elastomer. The comonomer, if used in a content of more than 50 percent by weight, may disadvantageously readily cause deterioration in properties with time.

The acrylic elastomer can have properties such as glass transition temperature, elastic modulus, viscoelasticity, and tackiness as suitably adjusted by selecting the type and content of the comonomer. Suitable adjustment of the properties, such as glass transition temperature, elastic modulus, viscoelasticity, and tackiness, of the acrylic elastomer enables the resin foam to have a lower glass transition temperature and a higher storage elastic modulus (E′) at 20° C.

The acrylic elastomer has a weight-average molecular weight of preferably, but not critically, from 30×10⁴ to 300×10⁴ and more preferably from 50×10⁴ to 250×10⁴. The acrylic elastomer, if having a weight-average molecular weight of less than 30×10⁴, may give cells that do not withstand the gas pressure and break upon expansion, resulting in insufficient cell growth or an insufficient expansion ratio. In contrast, the acrylic elastomer, if having a weight-average molecular weight of more than 300×10⁴, may not cause significant disadvantages but may be excessively hard (inflexible) upon molding.

The weight-average molecular weight of the acrylic elastomer may be determined in the following manner. Specifically, the acrylic elastomer is dissolved in a phosphoric acid solution in DMF, and the resulting solution is filtrated through a membrane filter. The filtrate is subjected to a molecular weight measurement using a high speed GPC system (device name “HLC-8320GPC” from Tosoh Corporation). The molecular weight is calculated as a molecular weight in terms of a polystyrene standard.

The elastomer has a glass transition temperature of preferably 30° C. or lower (e.g., from −60° C. to 30° C.) and more preferably 20° C. or lower (e.g., from −40° C. to 20° C.) so as to allow the resin foam according to the present invention to have a lower glass transition temperature. Of such elastomers, the acrylic elastomer can be readily designed so as to have a desired glass transition temperature by controlling molecular structures of monomers constituting the acrylic elastomer. An acrylic elastomer having a low glass transition temperature, when employed as the elastomer, enables easy control of the glass transition temperature of the resin foam by employing an active-energy-ray-curable compound in coexistence in the resin composition. Also from this viewpoint, the acrylic elastomer has a glass transition temperature of preferably 30° C. or lower (e.g., from −60° C. to 30° C.) and more preferably 20° C. or lower (e.g., from −40° C. to 20° C.).

The term “active-energy-ray-curable compound” refers to a compound that is cured upon irradiation with an active energy ray (e.g., an ultraviolet ray or an electron beam). The “active-energy-ray-curable compound” also includes a resin that is cured by an active energy ray (active-energy-ray-curable resin). Each of different active-energy-ray-curable compounds may be used alone or in combination.

In an embodiment, the resin foam according to the present invention is formed by subjecting the resin composition to expansion molding to give a molded article and further irradiating the molded article with an active energy ray. The resin foam in this embodiment has a crosslinked structure as a result of the reaction (curing) of the active-energy-ray-curable compound induced by active energy ray irradiation. This allows the resin foam to exhibit better shape retention and prevents deformation and shrinkage of the cell structure with time in the resin foam. This also allows the resin foam to have a higher storage elastic modulus (E′) at 20° C. In addition, the resin foam having such a crosslinked structure also has a satisfactory strength and excellent strain recovery upon compression (particularly excellent strain recovery upon compression at high temperatures) and can maintain an initial high expansion ratio obtained by expansion.

The active-energy-ray-curable compound is preferably a polymerizable unsaturated compound that is nonvolatile and has a low molecular weight in terms of a weight-average molecular weight of 10000 or less. The polymerizable unsaturated compound is exemplified by esters between (meth)acrylic acid and a polyhydric alcohol, such as phenoxypolyethylene glycol(meth)acrylates, ε-caprolactone(meth)acrylate, polyethylene glycol di(meth)acrylates, polypropylene glycol di(meth)acrylates, 1,4-butanediol di(meth)acrylate, tetraethylene glycol di(meth)acrylate, 1,6-hexanediol di(meth)acrylate, trimethylolpropane tri(meth)acrylate, tetramethylolmethane tetra(meth)acrylate, pentaerythritol tri(meth)acrylate, pentaerythritol tetra(meth)acrylate, and neopentyl glycol di(meth)acrylate; multifunctional polyester acrylates, urethane(meth)acrylates, multifunctional urethane acrylates, epoxy(meth)acrylates, and oligo ester(meth)acrylates. The polymerizable unsaturated compound may be a monomer or an oligomer. As used herein the term “(meth)acrylic” refers to “acrylic and/or methacrylic”; and the same is applied to other descriptions.

The active-energy-ray-curable compound preferably employs a bifunctional (meth)acrylate and a trifunctional (meth)acrylate in combination. This is preferred for the control of the glass transition temperature of the resin foam and for the satisfactory curing rate and curing efficiency of the resin composition upon the resin foam production. As used herein the term “bifunctional (meth)acrylate” refers to a compound having two (meth)acryloyl groups per molecule. The term “trifunctional (meth)acrylate” refers to a compound having three (meth)acryloyl groups per molecule.

The combination of a bifunctional (meth)acrylate and a trifunctional (meth)acrylate, when used as the active-energy-ray-curable compounds, is not limited, but is particularly preferably a combination of at least one bifunctional (meth)acrylate selected from the group consisting of polypropylene glycol di(meth)acrylates, polyethylene glycol di(meth)acrylates, and 1,6-hexanediol di(meth)acrylate with trimethylolpropane tri(meth)acrylate serving as a trifunctional (meth)acrylate.

In the combination use as the active-energy-ray-curable compound, the ratio (in weight ratio) of the bifunctional (meth)acrylate to the trifunctional (meth)acrylate is preferably, but not critically, from 3:1 to 1:3 and more preferably from 2:1 to 1:2.

The active-energy-ray-curable compound may be suitably selected according to the glass transition temperature of the elastomer as a material to form the resin foam so as to allow the resin foam to have a glass transition temperature of 30° C. or lower. Typically, the resin composition, when including two or more active-energy-ray-curable compounds, may include an active-energy-ray-curable compound that readily causes the resin foam to have a higher glass transition temperature, such as an active-energy-ray-curable resin having a glass transition temperature of higher than 30° C. However, the other active-energy-ray-curable compound than the active-energy-ray-curable compound that readily causes the resin foam to have a higher glass transition temperature may be suitably selected so that the resulting resin foam has a glass transition temperature of 30° C. or lower.

Though the content is not critical, the resin composition, if containing the active-energy-ray-curable compound(s) in an excessively high content, may cause the resin foam to have an excessively high hardness and to exhibit insufficient cushioning properties. In contrast, the resin composition, if containing the active-energy-ray-curable compound(s) in an excessively low content, may prevent the resin foam from maintaining a high expansion ratio. Typically, the resin composition may include the polymerizable unsaturated compound, when serving as the active-energy-ray-curable compound, in a content of preferably from 3 to 100 parts by weight and more preferably from 5 to 100 parts by weight per 100 parts by weight of the elastomer.

The elastomer and the active-energy-ray-curable compound are preferably used in such a combination as to be satisfactorily compatible with each other. The elastomer and the active-energy-ray-curable compound, when used in a satisfactorily compatible combination, do not separate from each other and have extremely good uniformity. This allows the resin composition to contain the active-energy-ray-curable compound in a higher content relative to the elastomer. Such a satisfactorily compatible combination of the elastomer and the active-energy-ray-curable compound allows the resin composition to include the polymerizable unsaturated compound as the active-energy-ray-curable compound in a higher content. Specifically, the resin composition can include the active-energy-ray-curable compound in a content of from 3 to 150 parts by weight and preferably from 5 to 120 parts by weight per 100 parts by weight of the elastomer.

Exemplary satisfactorily compatible combinations include a combination of an “acrylic elastomer” with an “ester between (meth)acrylic acid and a polyhydric alcohol”.

The elastomer and the active-energy-ray-curable compound, when used in the combination (satisfactorily compatible combination), allow the resin composition to include the active-energy-ray-curable compound in a higher content relative to the elastomer, and this allows the resin foam to exhibit better shape retention. When used in such a satisfactorily compatible combination and the active-energy-ray-curable compound is allowed to react to form a crosslinked structure, the elastomer molecular chain and the active-energy-ray-curable compound network form an interpenetrating network structure (IPN). This also advantageously allows the resin foam to have better shape retention. The resulting resin foam with better shape retention exhibits a higher storage elastic modulus (E′) at 20° C. and a higher strain recovery rate (80° C., 50% compression set).

The resin composition may include a photoinitiator. The presence of a photoinitiator may facilitate the formation of a crosslinked structure upon reaction of the active-energy-ray-curable compound to form the crosslinked structure. Each of different photoinitiators may be used alone or in combination.

Such photoinitiators are exemplified by, but not limited to, benzoin ether photoinitiators such as benzoin methyl ether, benzoin ethyl ether, benzoin propyl ether, benzoin isopropyl ether, benzoin isobutyl ether, 2,2-dimethoxy-1,2-diphenylethan-1-one, and anisole methyl ether; acetophenone photoinitiators such as 2,2-diethoxyacetophenone, 2,2-dimethoxy-2-phenylacetophenone, 1-hydroxycyclohexyl phenyl ketone, 4-phenoxydichloroacetophenone, and 4-t-butyl-dichloroacetophenone; α-ketol photoinitiators such as 2-methyl-2-hydroxypropiophenone and 1-[4-(2-hydroxyethyl)-phenyl]-2-hydroxy-2-methylpropan-1-one; aromatic sulfonyl chloride photoinitiators such as 2-naphthalenesulfonyl chloride; photoactive oxime photoinitiators such as 1-phenyl-1,1-propanedione-2-(o-ethoxycarbonyl)-oxime; benzoin photoinitiators such as benzoin; benzil photoinitiators such as benzil; benzophenone photoinitiators such as benzophenone, benzoylbenzoic acid, 3,3′-dimethyl-4-methoxybenzophenone, polyvinylbenzophenone, and α-hydroxycyclohexyl phenyl ketone; ketal photoinitiators such as benzyl dimethyl ketal; thioxanthone photoinitiators such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone, and dodecylthioxanthone; α-amino ketone photoinitiators such as 2-methyl-1-[4-(methylthio)phenyl]-2-morpholinopropan-1-one and 2-benzyl-2-dimethylamino-1-(4-morpholinophenyl)-butanone-1; and acylphosphine oxide photoinitiators such as 2,4,6-trimethylbenzoyl(diphenyl)phosphine oxide and bis(2,4,6-trimethylbenzoyl)-phenylphosphine oxide.

The resin composition may include the photoinitiator in a content of, though not critical, typically preferably from 0.01 to 10 parts by weight and more preferably from 0.05 to 5 parts by weight per 100 parts by weight of the elastomer.

The resin composition may further include a thermal crosslinking agent (elastomer-crosslinking agent). When the elastomer in the resin composition has a reactive functional group, the thermal crosslinking agent can react with the reactive functional group through heating to form a crosslinked structure. The thermal formation of the crosslinked structure advantageously allows the resin foam to exhibit better shape retention, to be resistant to deformation and shrinkage of the cell structure with time, and to provide satisfactory strain recovery. The thermal formation of the crosslinked structure also advantageously allows the resin foam to have a higher storage elastic modulus (E′) at 20° C. and a higher strain recovery rate (80° C., 50% compression set). Each of different thermal crosslinking agents may be used alone or in combination.

The thermal crosslinking agents are exemplified by polyisocyanates such as diphenylmethane diisocyanate, tolylene diisocyanate, and hexamethylene diisocyanate; and polyamines such as hexamethylenediamine, hexamethylenediamine carbamate, triethylenetetramine, tetraethylenepentamine, hexamethylenediamine carbamate, N,N″-dicinnamidine-1,6-hexanediamine, 4,4″-methylenebis(cyclohexylamine) carbamate, 4,4″-(2-chloroaniline), and isophthalic dihydrazide.

Among such thermal crosslinking agents, the polyamines are preferred, of which hexamethylenediamine, hexamethylenediamine carbamate, and isophthalic dihydrazide are more preferred.

The resin composition may contain the thermal crosslinking agent in a content of, though not critical, preferably from 0.01 to 10 parts by weight and more preferably from 0.05 to 6 parts by weight per 100 parts by weight of the elastomer. The thermal crosslinking agent, if contained in a content of less than 0.01 part by weight, may not sufficiently contribute to the crosslinked structure formation. The thermal crosslinking agent, if contained in a content of more than 10 parts by weight, may bleed out or adversely affect the strain recovery of the resin foam.

The resin composition may include a thermal crosslinking agent in combination with an elastomer having a reactive functional group. The resin composition may also include an elastomer having a reactive functional group, an elastomer having no reactive functional group, and a crosslinking agent having a reactive functional group in combination.

In particular, the resin composition, when including a thermal crosslinking agent, preferably includes a crosslinking coagent (elastomer-crosslinking coagent) simultaneously. This is because the crosslinking coagent allows the thermal crosslinking agent to exhibit further better crosslinking efficiency. Each of different crosslinking coagents may be used alone or in combination.

The crosslinking coagent is not limited. Typically, when a polyamine (e.g., hexamethylenediamine) is used as the thermal crosslinking agent, exemplary crosslinking coagents to be used in combination include guanidine compounds such as 1,3-diphenylguanidine, 1,3-di-o-tolylguanidine, tetramethylguanidine, and dibutylguanidine.

The resin composition may contain the crosslinking coagent in a content of, though not critical, preferably from 0.05 to 6 parts by weight per 100 parts by weight of the elastomer.

The resin composition preferably includes inorganic particles (powder particles). Specifically, the resin foam according to the present invention preferably includes inorganic particles. The inorganic particles functionally serve as a foam-nucleating agent upon expansion molding of the resin composition. The resin composition, when containing inorganic particles, gives a resin foam in a good expansion state.

The inorganic particles are exemplified by, but not limited to, powdered talc, silica, alumina, zeolite, calcium carbonate, magnesium carbonate, barium sulfate, zinc oxide, titanium oxide, aluminum hydroxide, magnesium hydroxide, mica, montmorillonite and other clay, carbon particles, glass fiber, and carbon tubes. Each of different inorganic particles may be used alone or in combination.

Of such inorganic particles, preferred are powdered particles having an average particle diameter (particle size) of from 0.1 to 20 μm. Powdered particles, if having an average particle diameter of less than 0.1 μm, may fail to sufficiently function as a nucleating agent; and, if having a particle size of more than 20 μm, may cause gas escaping (outgassing) upon expansion molding.

The inorganic particles may have been subjected to a surface treatment to increase the affinity with the resin composition. This may prevent outgassing upon expansion and the cell structure shrinkage immediately after expansion of the resin composition. A surface treatment, when applied to such inorganic fine particles, may suppress delamination or separation at the interface between the inorganic particles and the resin composition and give a resin foam in a good expansion state. The surface treatment is exemplified by treatments with a silane coupling agent, with silica, with an organic acid, and with a surfactant, respectively. The inorganic particles may be subjected to one surface treatment alone or two or more different surface treatments.

The resin composition may include the inorganic particles in a content of, though not critical, typically preferably from 5 to 150 parts by weight and more preferably from 10 to 120 parts by weight per 100 parts by weight of the elastomer. The resin composition, if including the inorganic particles in a content of less than 5 parts by weight, may give a heterogenous resin foam; and, if including the inorganic particles in a content of more than 150 parts by weight, may have an excessively high viscosity and suffer from outgassing upon expansion molding to cause poor expansion properties.

The resin composition may further include flame-retardant powder particles (e.g., powdered flame retardants) as the inorganic particles. The resin foam according to the present invention includes one or more elastomers and therefore has a flammable nature (this is also naturally a disadvantage). Particularly when the resin foam is applied to uses essentially requiring flame retardancy, such as in electric/electronic devices, the resin composition preferably contains flame-retardant powder particles as the inorganic particles. Each of different types of flame-retardant powder particles may be used alone or in combination. The flame-retardant powder particles may also be used in combination with powder particles having no flame retardancy (powder particles other than flame retardants).

The flame-retardant powder particles are preferably, but not limited to, inorganic flame retardants. The inorganic flame-retardants may be any of bromine-containing flame-retardants, chlorine-containing flame-retardants, phosphorus-containing flame-retardants, and antimony-containing flame-retardants. However, the chlorine-containing flame retardants and bromine-containing flame retardants evolve a gaseous component upon combustion, which gaseous component is harmful to the human body and corrosive to devices or appliances; and the phosphorus-containing flame retardants and antimony-containing flame retardants are disadvantageously harmful and/or explosive. To avoid these disadvantages, the inorganic flame-retardants are preferably non-halogen-non-antimony inorganic flame-retardants. The non-halogen-non-antimony inorganic flame retardants are exemplified by hydrated metal compounds such as aluminum hydroxide, magnesium hydroxide, hydrates of magnesium oxide-nickel oxide, and hydrates of magnesium oxide-zinc oxide. Such hydrated metal oxides may be subjected to a surface treatment.

The resin composition may include flame-retardant powder particles (e.g., any of powdered flame retardants) as the inorganic particles in a content of, though not critical, preferably from 5 to 150 percent by weight and more preferably from 10 to 120 percent by weight based on the total weight of the resin composition. The resin composition, if including the flame-retardant powder particles in an excessively low content, may not enjoy flame retardant effects; and, in contrast, if including the flame-retardant powder particles in an excessively high content, may give a foam with an insufficiently high expansion ratio.

The resin composition may include an antioxidant and/or an age inhibitor. The antioxidant and/or agent inhibitor, when contained, may allow the resin foam to have better thermal stability and better weatherability and to exhibit better working stability upon resin foam shaping. Each of different antioxidants and different age inhibitors may be used alone or in combination, respectively.

The antioxidant is exemplified by phenol antioxidants such as hindered phenol antioxidants; and amine antioxidants such as hindered amine antioxidants. Each of different antioxidants may be used alone or in combination.

The hindered phenol antioxidants are exemplified by pentaerythritol tetrakis[3-(3,5-di-tert-butyl-4-hydroxyphenyl)propionate] (available under the trade name “Irganox 1010” from BASF SE), octadecyl-3-(3,5-di-tert-butyl-4-hydroxyphenyl)propionate (available under the trade name “Irganox 1076” from BASF SE), 4,6-bis(dodecylthiomethyl)-o-cresol (available under the trade name “Irganox 1726” from BASF SE), triethylene glycol-bis[3-(3-tert-butyl-5-methyl-4-hydroxyphenyl)propionate] (available under the trade name “Irganox 245” from BASF SE), bis(2,2,6,6-tetramethyl-4-piperidyl)sebacate (available under the trade name “TINUVIN 770” from BASF SE), and a polycondensate of dimethyl succinate with 4-hydroxy-2,2,6,6-tetramethyl-1-piperiridine-ethanol (poly(4-hydroxy-2,2,6,6-tetramethyl-1-piperidine ethanol-alt-1,4-butanedioic acid) (available under the trade name “TINUVIN 622” from BASF SE). Among them, preferred examples are triethylene glycol-bis[3-(3-tert-butyl-5-methyl-4-hydroxyphenyl)propionate] (available under the trade name “Irganox 245” from BASF SE) and pentaerythritol tetrakis[3-(3,5-di-tert-butyl-4-hydroxyphenyl)propionate] (available under the trade name “Irganox 1010” from BASF SE) for satisfactory working stability upon molding and curability upon active energy ray irradiation.

The hindered amine antioxidants are preferably exemplified by, but not limited to, bis(1,2,2,6,6-pentamethyl-4-piperidyl)sebacate(methyl) (available under the trade name “TINUVIN 765” from BASF SE) and bis(1,2,2,6,6-pentamethyl-4-piperidyl) [[3,5-bis(1,1-dimethylethyl)-4-hydroxyphenyl]methyl]butylmalonate (available under the trade name “TINUVIN 765” from BASF SE).

The age inhibitors are exemplified by phenolic age inhibitors and amine age inhibitors. Each of different age inhibitors may be used alone or in combination.

The phenolic age inhibitors are exemplified by commercial products available under the trade name “SUMILIZER GM” (from Sumitomo Chemical Co., Ltd.) and the trade name “SUMILIZER GS” (from Sumitomo Chemical Co., Ltd.).

The amine age inhibitors are exemplified by 4,4′-bis(α,α-dimethylbenzyl)diphenylamine (available under the trade name “Noclac CD” from Ouchi Shinko Chemical Industrial Co., Ltd. and the trade name “Naugard 445” from Crompton Corporation), N,N′-diphenyl-p-phenylenediamine (available under the trade name “Noclac DP” from Ouchi Shinko Chemical Industrial Co., Ltd.), and p-(p-toluenesulfonylamido)diphenylamine (available under the trade name “Noclac TD” from Ouchi Shinko Chemical Industrial Co., Ltd.). Among them, 4,4′-bis(α,α-dimethylbenzyl)diphenylamine (available under the trade name “Naugard 445” from Crompton Corporation) or a similar compound is preferred for satisfactory working stability upon molding and curability upon active energy ray irradiation.

The resin composition may include an antioxidant and/or an age inhibitor in a content of, though not critical, preferably from 0.05 to 10 parts by weight and more preferably from 0.1 to 10 parts by weight per 100 parts by weight of the elastomer. When the resin composition includes both the antioxidant and agent inhibitor, the content is a total amount of them. The antioxidant and/or age inhibitor, if contained in a content of less than 0.05 part by weight, may not exhibit sufficient advantageous effects; and, if contained in a content of more than 10 parts by weight, may disadvantageously cause expansion failure (foaming defects) upon the resin foam preparation from the resin composition and/or bleed out to the resulting resin foam surface.

The resin composition may further include one or more additives as appropriate. The additives are not limited and include various additives generally used in expansion molding. Specifically, the additives are exemplified by foaming nucleators, crystal nucleators, plasticizers, lubricants, colorants (e.g., pigments and dyestuffs), ultraviolet absorbers, fillers, reinforcers, antistatic agents, surfactants, tension modifiers, shrinkage inhibitors, flowability improvers, clay, vulcanizers, coupling agents (surface preparation agents), and flame retardants in forms other than powder. The resin composition may contain these additives in contents that may be those employed in common resin foams production, though not critical. These additives may be used under suitable control within ranges not inhibiting the resin foam from exhibiting desired satisfactory properties such as strength, flexibility, and strain recovery.

The resin composition is preferably such a resin composition as to give, through curing under a specific condition (curing condition A), a cured article which has a glass transition temperature of 30° C. or lower, so as to give a resin foam having a storage elastic modulus and a glass transition temperature both at desired levels. The curing condition A is as follows:

Curing condition: the resin composition is cured by molding the resin composition into a sheet having a thickness of 0.3 mm to give a resin molded article; irradiating the resin molded article with an electron beam at an acceleration voltage of 250 kV to a dose of 200 kGy; and leaving the irradiated article stand at an ambient temperature of 170° C. for one hour.

The resin composition has a storage elastic modulus (E′) of 1.0×10⁷ Pa or more and more preferably 2.0×10⁷ Pa or more at 20° C. The storage elastic modulus (E′) of the resin composition at 20° C. may be determined by obtaining a sheet from the resin composition under the curing condition A and subjecting the sheet to a dynamic viscoelastic measurement.

Upon production of a resin foam, the expansion state is maintained by the tension against the pressure of the gas (gas as a blowing agent), but the gas gradually diffuses and migrates through the cell walls, and the foamed structure (expanded structure) shrinks during this process. When the resin composition has a high storage elastic modulus at 20° C., the cells can maintain large stress inside thereof and can counteract the shrinkage force due to the shrinkage stress. Thus, the foamed structure can be fixed while maintaining the expansion state.

The resin composition may be obtained typically, but not limitatively, by mixing, kneading, and/or melting/mixing components such as an elastomer and an active-energy-ray-curable compound, as well as optional components such as a thermal crosslinking agent, a crosslinking coagent, a photoinitiator, inorganic particles, and additives.

A resin foam according to an embodiment of the present invention is obtained from the resin composition. In a more preferred embodiment, a resin foam according to the present invention is obtained by subjecting the resin composition to expansion molding to give a molded article and irradiating the molded article with an active energy ray. In a furthermore preferred embodiment, a resin foam is obtained by subjecting the resin composition to expansion molding to give a molded article, and further subjecting the molded article to active energy ray irradiation and heating. Typically, the resin foam according to the present invention may be obtained by subjecting the resin composition to expansion molding to give a molded article, irradiating the molded article with an active energy ray, and heating the molded article after irradiation.

More specifically, in a preferred embodiment, a resin foam according to the present invention is produced by subjecting a resin composition including at least an elastomer and an active-energy-ray-curable compound to expansion molding to form a foamed structure; irradiating the foamed structure with an active energy ray to cure the active-energy-ray-curable resin to thereby form a crosslinked structure. In a more preferred embodiment, a resin foam according to the present invention is produced by subjecting a resin composition to expansion molding to form a foamed structure, the resin composition including at least an elastomer having a reactive functional group, an active-energy-ray-curable compound, and a thermal crosslinking agent; irradiating the foamed structure with an active energy ray to cure the active-energy-ray-curable resin to form a crosslinked structure; and further heating the resulting article to form a crosslinked structure by the action between the thermal crosslinking agent and the reactive functional group of the elastomer. As used herein the term “foamed structure” refers to a foam which is obtained by expansion molding of the resin composition, which has a foam structure (foamed structure or cell structure), and which is before the formation of a crosslinked structure. A thickness, shape, and other dimensions of the foamed structure are not limited and may be suitably selected according to the necessity and intended use. The foamed structure may be processed into any of various shapes and thicknesses.

The blowing agent for use in expansion molding of the resin composition is not limited, as long as it is gaseous at room temperature and normal atmospheric pressure, is inert to the elastomer, and the elastomer is impregnable therewith. As used herein the term “gas inert to the elastomer, and the elastomer is impregnable therewith” is also referred to as an “inert gas”.

The inert gas is exemplified by rare gases (e.g., helium and argon), carbon dioxide, nitrogen, and air. Each of different gases may be used in combination as a mixture. Among them, carbon dioxide and nitrogen are preferred, of which carbon dioxide is more preferred so as to impregnate the elastomer in a large amount at a high rate.

To impregnate the elastomer at a higher rate, the inert gas is preferably a high-pressure gas (of which high-pressure carbon dioxide gas or high-pressure nitrogen gas is particularly preferred); and is more preferably a fluid in a liquid state (of which liquefied carbon dioxide or liquefied nitrogen is particularly preferred) or a fluid in a supercritical state (of which carbon dioxide gas in a supercritical state or nitrogen gas in a supercritical state is particularly preferred). The inert gas, when being a fluid in a liquid state or in a supercritical state, has higher solubility and is soluble in or miscible with the elastomer in a high concentration. Use of the inert gas in the above state gives fine cells. This is because as follows. Because of its high concentration after impregnation as above, the inert gas generates a larger number of cell nuclei upon an abrupt pressure drop (decompression) after impregnation. The cell nuclei grow to form cells, which are present in a higher density than in a foam having the same porosity but produced with a gas in another state. Carbon dioxide has a critical temperature and a critical pressure of 31° C. and 7.4 MPa, respectively.

Expansion molding of the resin composition may be performed according to a batch system or continuous system. In the batch system, the resin composition is shaped into a suitable form such as a sheet to give an unfoamed resin molded article (unfoamed molded article), the unfoamed resin molded article is impregnated with a blowing agent (of which the high-pressure gas, the fluid in a liquid state, or the fluid in a supercritical state is preferred) and then released from the pressure to allow the molded article to expand. In the continuous system, molding and expansion are performed simultaneously, in which the resin composition together with a blowing agent (of which the high-pressure gas, the fluid in a liquid state, or the fluid in a supercritical state is preferred) are kneaded under a pressure (under a load), and the kneadate is molded into a molded article and, simultaneously, decompressed.

As has been described above, expansion in the expansion molding of the resin composition is preferably performed by impregnating the resin composition with a blowing agent and decompressing the resulting article. Typically, expansion in the expansion molding of the resin composition may be performed through the steps of molding the resin composition to form an unfoamed resin molded article; impregnating the unfoamed resin molded article with a blowing agent; and decompressing the impregnated article. The expansion may also be performed through the steps of melting the resin composition; impregnating the molten resin composition with a blowing agent under a pressure; and molding the impregnated article simultaneously with decompression.

Specifically, an unfoamed resin molded article upon expansion molding of the resin composition according to a batch system may be produced typically by molding the resin composition through an extruder such as a single-screw extruder or a twin-screw extruder; or by uniformly kneading the resin composition using a kneader equipped with one or more blades typically of a roller, cam, kneader, or Banbury type, and press-forming the kneadate typically with a hot-plate press to a predetermined thickness; or by molding the resin composition with an injection molding machine. The molding (shaping) may be performed according to a suitable procedure to give a molded article having a desired shape and thickness. In the batch system, the resulting unfoamed resin molded article is subjected to the steps of gas impregnation, decompression, and, where necessary, heating to form cells. In the gas impregnation step, the unfoamed resin molded article is placed in a pressure-tight vessel (high-pressure vessel), a gas (e.g., carbon dioxide or nitrogen) as the blowing agent is injected or introduced into the vessel, and the unfoamed resin molded article is impregnated with the gas under a high pressure. In the decompression step, at the time when being sufficiently impregnated with the gas, the unfoamed resin molded article is released from the pressure (the pressure is usually lowered to the atmospheric pressure) to thereby generate cell nuclei in the elastomer. In the heating step, heating is performed to allow the cell nuclei to grow. Alternatively, the cell nuclei may be allowed to grow at room temperature without providing the heating step. After the cell growth in the above manner, the article is rapidly cooled as appropriate typically with cold water to fix its shape and yields a foam. The unfoamed resin molded article is not limited in its shape and may be in the form typically of a roll, sheet, or plate. The introduction of the gas as the blowing agent may be performed continuously or discontinuously. The heating for cell nuclei growth may be performed according to a known or customary procedure such as heating with a water bath, oil bath, hot roll, hot-air oven, far-infrared rays, near-infrared rays, or microwaves. The unfoamed resin molded article to be expanded may also be produced by any molding or shaping process other than the extrusion molding, press forming, and injection molding.

According to the continuous system, a foam may be obtained in the following manner. Specifically, the foam may be produced through a kneading-impregnation step and a molding-decompression step. In the kneading-impregnation step, a gas (e.g., carbon dioxide or nitrogen) as a blowing agent is injected (introduced) while kneading the resin composition using an extruder such as a single-screw extruder or twin-screw extruder. Thus, the resin composition is sufficiently impregnated with the gas under a high pressure. In the molding-decompression step, molding and expansion are performed simultaneously. Specifically, the resin composition impregnated with the gas is extruded typically through a die arranged at the extruder nose and thereby released from the pressure (the pressure is usually lowered to the atmospheric pressure). In some cases (as necessary), the step of heating to enhance cell growth may be further provided. After cell growth as above, the article is rapidly cooled as appropriate typically with cold water to fix the shape and yields a foam. The kneading-impregnation step and the molding-decompression step may also be performed typically with an injection molding machine instead of an extruder. The procedure herein may be chosen so as to obtain a foam of a sheet, a prism, or another arbitrary form.

The blowing agent (gas serving as the blowing agent) may be incorporated in an amount of, though not critical, typically preferably from 2 to 10 percent by weight and more preferably from 3 to 8 percent by weight relative to the total weight of the resin composition. The blowing agent may be incorporated in an amount suitably adjusted to provide a density and an expansion ratio at desired levels. The resin composition, if incorporated with the blowing agent in an excessively low amount, may exhibit extremely low foamability; and, if incorporated with the blowing agent in an excessively high amount, may suffer from locally coarse cells.

The unfoamed resin molded article or the resin composition is impregnated with the blowing agent under a pressure in the gas impregnation step in the batch system or in the kneading-impregnation step in the continuous system. The pressure herein may be suitably selected in consideration typically of the gas type and operability. When carbon dioxide, for example, is used as the blowing agent, the pressure is preferably 3 MPa or more (e.g., from 3 to 50 MPa) and more preferably 4 MPa or more (e.g., from 4 to 30 MPa). The impregnation, if performed at a pressure of less than 3 MPa, may cause excessive cell growth upon expansion to cause excessively large cell diameters. This may disadvantageously cause, for example, an insufficient dustproof effect. The reasons for this are as follows. When impregnation is performed under a low pressure, the amount of the impregnated gas is relatively small, and cell nuclei grow at a lower rate as compared to impregnation under a higher pressure. As a result, cell nuclei are formed in a smaller number. This increases, rather than decreases, the gas amount per cell, resulting in excessively large cell diameters. In a pressure range of less than 3 MPa, only a slight change in impregnation pressure may result in considerable changes in cell diameter and cell number (cell density), and this may readily impede the control of cell diameter and cell number (cell density). A higher pressure is preferred from the viewpoint of impregnating the resin composition with the blowing agent gas rapidly and uniformly.

The unfoamed resin molded article or the thermoplastic resin composition is impregnated with the blowing agent at a temperature in the gas impregnation step in the batch system or in the kneading-impregnation step in the continuous system. The temperature herein may vary typically depending on the types of the gas to be used as the blowing agent and the elastomer and can be chosen within a wide range. In consideration typically of operability, the temperature may be from 10° C. to 200° C. Typically when a sheet-form unfoamed resin molded article is impregnated with a blowing agent gas in the batch system, the impregnation temperature is preferably from 10° C. to 200° C. and more preferably from 40° C. to 200° C. When the blowing agent gas is injected into and kneaded with the resin composition in the continuous system, the temperature is preferably from 10° C. to 100° C. and more preferably from 40° C. to 100° C. When carbon dioxide is used as a high-pressure gas, the impregnation is performed at a temperature (impregnation temperature) of preferably 32° C. or higher, and especially preferably 40° C. or higher, in order to maintain its supercritical state.

Decompression in the decompression step may be performed at a rate of, though not critical, preferably from 5 to 300 MPa/second so as to obtain uniform fine cells. Heating in the heating step may be performed at a temperature of typically preferably from 40° C. to 250° C. and more preferably from 60° C. to 250° C.

The production process as above can produce a foam with a high expansion ratio and can advantageously produce a thick foam. This is advantageous when a thick resin foam is to be produced according to the present invention. Typically, when a foam is produced according to the continuous system, the die gap (die clearance) at the extruder nose should be designed to be as narrow as possible (generally from 0.1 to 1.0 mm) for maintaining the pressure in the extruder during the kneading-impregnation step. To obtain a thick foam, the resin composition extruded through such a narrow gap should be expanded at a high expansion ratio. According to customary techniques, however, such a high expansion ratio is not obtained, and the resulting foam is limited to thin one (e.g., one having a thickness of from about 0.5 to about 2.0 mm). By contrast, the production process using a gas as the blowing agent can continuously give foams having a final thickness of from 0.50 to 5.00 mm.

The foamed structure is irradiated with an active energy ray to form a crosslinked structure by the action of the active-energy-ray-curable compound. The active energy ray is exemplified by, but not limited to, ionizing radiation such as alpha rays, beta rays, gamma rays, neutron beams, and electron beams; and ultraviolet rays. Among them, ultraviolet rays and electron beams are preferred.

Energy, time, procedure, and other conditions or parameters in the active energy ray irradiation are not limited, as long as capable of forming a crosslinked structure by the action of the active-energy-ray-curable compound. Typically in an embodiment, the foamed structure is in a sheet form, and an ultraviolet ray is employed as the active energy ray. In this embodiment, the active energy ray irradiation may be performed by irradiating one side of the sheet-form foamed structure with an ultraviolet ray at an irradiation energy of 750 mJ/cm²; and subsequently irradiating the other side with an active energy ray at an irradiation energy of 750 mJ/cm². In another embodiment, the foamed structure is in a sheet form, and an electron beam is employed as the active energy ray. In this embodiment, the active energy ray irradiation may be performed by irradiating one side of the sheet-form foamed structure with an electron beam to a dose of 100 kGy; and subsequently irradiating the other side with an electron beam to a dose of 100 kGy. In the embodiment, the active energy ray irradiation may also be performed by irradiating one side of the sheet-form foamed structure with an electron beam to a dose of 200 kGy; and subsequently irradiating the other side with an electron beam to a dose of 200 kGy.

Heating is performed to form a crosslinked structure by the action of the thermal crosslinking agent. The heating is not limited, as long as capable of forming a crosslinked structure by the action of the thermal crosslinking agent. The heating may be performed typically by leaving the article at an ambient temperature of from 100° C. to 250° C. (preferably from 120° C. to 200° C.) for a duration of from 1 minute to 10 hours (preferably from 30 minutes to 8 hours, and more preferably from 1 hour to 5 hours). The ambient temperature can be obtained by a known heating process such as heating with an electrothermal heater, heating with an infrared ray or another electromagnetic wave, or heating on a water bath.

The thickness, density, expansion ratio, and other factors of the resin foam according to the present invention can be adjusted by suitably selecting conditions and parameters according to the component types of the gas to be used as the blowing agent and of the elastomer. The conditions and parameters include the temperature, pressure, time, and other operational conditions in the gas impregnation step or kneading-impregnation step; the decompression rate, temperature, pressure, and other operational conditions in the decompression step or molding-decompression step; and the heating temperature and other conditions in the heating step subsequent to the decompression or to molding-decompression. Typically, a resin foam having an expansion ratio of 5 times or more can be easily obtained in the following manner. A resin composition containing at least an acrylic elastomer and an active-energy-ray-curable compound is impregnated with carbon dioxide as a blowing agent under the condition of a temperature of from 60° C. to 100° C. and a pressure of from 5 to 30 MPa; the impregnated resin article is decompressed to expand; and, where necessary, the expanded article is subjected to active energy ray irradiation and/or heating.

As has been described above, the resin foam according to the present invention is preferably obtained by a production process including the steps of (1) subjecting the resin composition to expansion molding; and (2) irradiating the resulting article with an active energy ray. The resin foam is more preferably obtained by a production process further including the step (3) of heating in addition to the step (1) of subjecting the molded article to expansion molding and the step (2) of irradiating the resulting article with an active energy ray.

The resin foam according to the present invention has a high expansion ratio and exhibits satisfactory cushioning properties. The resin foam has satisfactory shape retention, is resistant to deformation/shrinkage of the cell structure, and exhibits good strain recovery.

The resin foam according to the present invention has satisfactory strain recovery even after being held under compression at high temperatures. This is because as follows. The resin foam excels typically in strength, flexibility, cushioning properties, and compressive strain recovery and is designed to have a glass transition temperature of 30° C. or lower. Even when the resin foam undergoes thermal deformation of the material, the composition (material) is resistant to structural relaxation in a temperature range of higher than 30° C. This allows the resin foam to exhibit satisfactory recovery (restitution) at high temperatures.

For these reasons, the resin foam according to the present invention is very useful typically as internal insulators in electronic devices, cushioning materials, sound insulators, heat insulators, food packaging materials, clothing materials, and building materials.

The resin foam according to the present invention may have a pressure-sensitive adhesive layer on its surface. Typically, the resin foam according to the present invention, when in a sheet form, may have a pressure-sensitive adhesive layer on one or both sides thereof. The resin foam may further have a transparent or colored film (protective film) on the pressure-sensitive adhesive layer. The film is exemplified by polyolefin films, PET films, and polyimide films. The resin foam according to the present invention, as bearing the film by the medium of the pressure-sensitive adhesive layer, may be suitably selected according to the intended use. The resin foam according to the present invention, when having a pressure-sensitive adhesive layer, is advantageous to be fixed to a predetermined portion.

The resin foam according to the present invention, when being in a sheet form, namely, when being a resin foam sheet, may have a surface layer on one or both sides thereof. The surface layer, when present on the resin foam according to the present invention, may impart resilience or firmness to the resin foam. The resulting resin foam exhibits good handleability upon die cutting or machining. The surface layer, when present on the resin foam, may suppress infiltration or permeation of water or another liquid from the surface and contribute to better sealability.

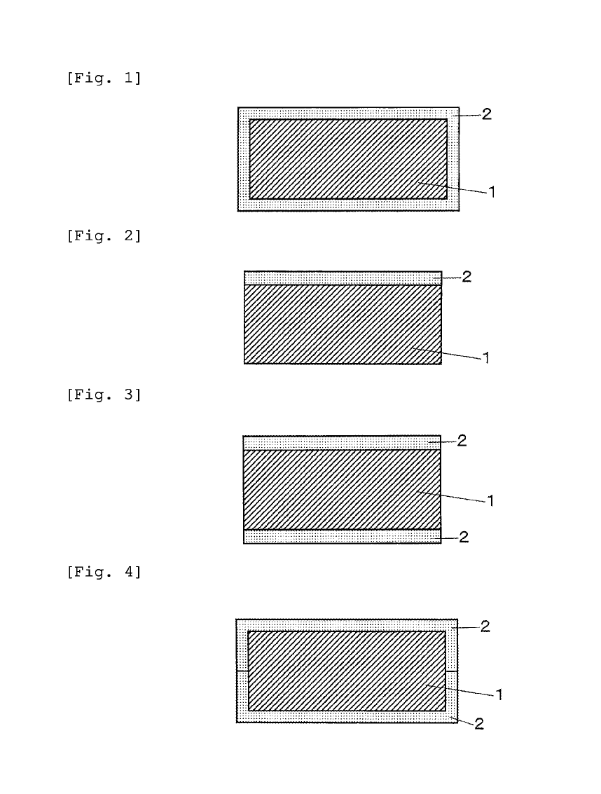

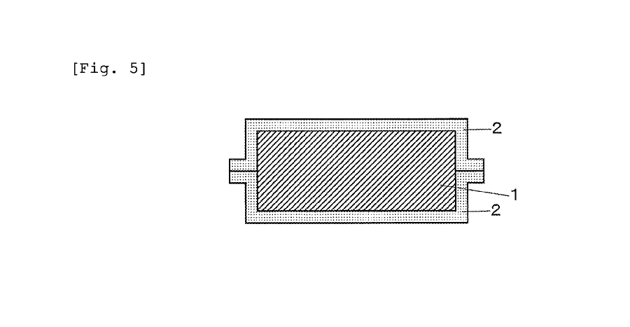

Specifically, the resin foam according to the present invention may serve as a resin foam constituting a foam laminate including the resin foam according to the present invention and a surface layer present on the resin foam. The foam laminate is exemplified by those illustrated in FIGS. 1 to 5. The foam laminate includes the resin foam (resin foam sheet) and a surface layer. In some embodiments, the surface layer is present all over the resin foam (e.g., the embodiments illustrated in FIGS. 1, 4, and 5). In some other embodiments, the surface layer is partially present on the resin foam (e.g., the embodiments illustrated in FIGS. 2 and 3). Likewise, in some embodiments, the surface layer is present on one side of the resin foam (e.g., the embodiment illustrated in FIG. 2). In some other embodiments, the surface layer is present on both sides of the resin foam (e.g., the embodiments illustrated in FIGS. 1, 3, 4, and 5). Specifically, the foam laminate is exemplified by the foam laminates illustrated in FIGS. 1 to 5. In FIGS. 1 to 5, Reference signs 1 and 2 stand for the resin foam and the surface layer, respectively.

The surface layer is preferably, but not limited to, a resin in a sheet form (resin sheet). The resin sheet may be a sheet made from a material the same as, or other than, that of the resin foam according to the present invention. When the foam laminate has two or more surface layers, resin sheets to constitute the surface layers may be made from materials the same as or different from each other.

When the surface layer is a sheet made from another material than that of the resin foam according to the present invention, the other material is exemplified by, but not limited to, polypropylenes (melting point: 170° C.), nylon 6 (melting point: 225° C.), nylon 66 (melting point: 267° C.), poly(ethylene terephthalate)s (melting point: 260° C.), poly(vinyl chloride)s (melting point: 180° C.), poly(vinylidene chloride)s (melting point: 212° C.), polytetrafluoroethylenes (melting point: 320° C.), poly(vinylidene fluoride)s (melting point: 210° C.), polyimides, and polyetherimides. Among them, materials having a high melting point are preferred from the viewpoint of the resin foam thermal stability. Specifically, materials having a melting point of 80° C. or higher are preferred, of which those having a melting point of 130° C. or higher are more preferred.

The sheet made from another material than that of the resin foam according to the present invention may be made from one resin or two or more resins.

Though not critical, the surface layer preferably has a thickness of 1 μm or more so as to have a satisfactory strength.

The foam laminate may be produced by providing a surface layer on the resin foam according to the present invention. The surface layer may be provided on the resin foam according to the present invention in the following manner. Typically, a sheet to constitute the surface layer is bonded at its end by thermobonding or by bonding through a pressure-sensitive adhesive layer or adhesive layer to form the surface layer. Alternatively, a pressure-sensitive adhesive layer or adhesive layer is applied to the sheet to constitute the surface layer, and the resulting sheet is bonded onto the resin foam according to the present invention by the medium of the pressure-sensitive adhesive layer or adhesive layer.

The foam laminate, as having the surface layer, has satisfactory rigidity and can be handled well upon die cutting or machining. The foam laminate, as having the surface layer to suppress infiltration of water or another liquid from the surface to inside, exhibits superior sealability.

### EXAMPLES

The present invention will be illustrated in further detail with reference to several examples below, which are by no means intended to limit the scope of the invention.

### Example 1

Initially, an acrylic elastomer was prepared from 85 parts by weight of butyl acrylate, 15 parts by weight of acrylonitrile, and 6 parts by weight of acrylic acid. The acrylic elastomer had an acrylic acid content of 5.67 percent by weight, a weight-average molecular weight (molecular weight in terms of a polystyrene standard) of 217×10⁴, and a glass transition temperature of −20° C. Subsequently, materials were prepared as 100 parts by weight of the acrylic elastomer; 45 parts by weight of a polypropylene glycol diacrylate (a bifunctional acrylate, trade name “ARONIX M270” supplied by Toagosei Co., Ltd., glass transition temperature: −32° C.) as an active-energy-ray-curable compound; 30 parts by weight of trimethylolpropane trimethacrylate (a trifunctional acrylate, trade name “NK Ester TMPT” supplied by Shin-Nakamura Chemical Co., Ltd., glass transition temperature as a homopolymer: 250° C. or higher) as an active-energy-ray-curable compound; 50 parts by weight of magnesium hydroxide (trade name “EP1-A” supplied by Konoshima Chemical Co., Ltd.) as inorganic particles; 2 parts by weight of hexamethylenediamine (trade name “diak No. 1” supplied by E. I. du Pont de Nemours & Co.) as an elastomer-crosslinking agent (thermal crosslinking agent); 2 parts by weight of 1,3-di-o-tolylguanidine (trade name “Nocceler DT” supplied by Ouchi Shinko Chemical Industrial Co., Ltd.) as an elastomer-crosslinking coagent; and 8 parts by weight of a phenolic age inhibitor (trade name “SUMILIZER GM” supplied by Sumitomo Chemical Co., Ltd.). The materials were charged into a twin-blade compact dispersion kneader (device name “TD-10-20 MDX” supplied by Toshin Co., Ltd., mixing capacity: 10 L), kneaded under the condition of a blade rotation speed of 30 rpm and a temperature of 80° C. for 40 minutes, and yielded a resin composition.

The resin composition for expansion was molded to give an unfoamed resin molded article, this was pulverized to a size of several millimeters, the pulverized product was fed through a constant-volume feeder to a single-screw extruder (device name “φ 40 Single-screw Extruder” supplied by PLA GIKEN CO., LTD., screw diameter: 40 mm in diameter, L/D: 30, screw: a full-flighted screw having a conically tapered root-diameter). While kneading the pulverized product under the condition of a temperature of 80° C., carbon dioxide was injected (introduced) in a gas amount of 5 percent by weight (such an amount as to be 5 parts by weight per 100 parts by weight of the resin composition) to impregnate the resin composition sufficiently with carbon dioxide. The carbon dioxide was fed as a high-pressure carbon dioxide by pressurizing to a fed gas pressure of 28 MPa using a pump. The injected carbon dioxide immediately became a supercritical state because the single-screw extruder had a preset temperature of 80° C.

Next, the resin composition impregnated with carbon dioxide was extruded through a circular die at the extruder nose into the atmosphere, thereby decompressed to the atmospheric pressure, expanded, and yielded a sheet-form foamed structure. This step was a molding-decompression step, in which molding and expansion were simultaneously performed.

The foamed structure was irradiated with an electron beam (acceleration voltage: 250 kV) on both sides once per one side to a dose of 100 kGy per one side. The electron beam irradiation allowed the active-energy-ray-curable compound to react to form a crosslinked structure.

After the electron beam irradiation, the resulting article was subjected to a heating treatment by leaving stand at an ambient temperature of 170° C. for one hour. The heating treatment allowed the elastomer-crosslinking agent to react to form a crosslinked structure.

Thus, a foam was obtained as a sheet having a thickness of about 5 mm.

### Example 2

Initially, an acrylic elastomer was prepared from 85 parts by weight of butyl acrylate, 15 parts by weight of acrylonitrile, and 6 parts by weight of acrylic acid. The acrylic elastomer had an acrylic acid content of 5.67 percent by weight, a weight-average molecular weight (molecular weight in terms of a polystyrene standard) of 217×10⁴, and a glass transition temperature of −20° C. Subsequently, materials were prepared as 100 parts by weight of the acrylic elastomer; 30 parts by weight of a polypropylene diglycol acrylate (a bifunctional acrylate, trade name “ARONIX M270” supplied by Toagosei Co., Ltd., glass transition temperature: −32° C.) as an active-energy-ray-curable compound; 45 parts by weight of trimethylolpropane trimethacrylate (a trifunctional acrylate, trade name “NK Ester TMPT” supplied by Shin-Nakamura Chemical Co., Ltd., glass transition temperature as a homopolymer: 250° C. or higher) as an active-energy-ray-curable compound; 50 parts by weight of magnesium hydroxide (trade name “EP1-A” supplied by Konoshima Chemical Co., Ltd.) as inorganic particles; 2 parts by weight of hexamethylenediamine (trade name “diak No. 1” supplied by E. I. du Pont de Nemours & Co.) as an elastomer-crosslinking agent (thermal crosslinking agent); 2 parts by weight of 1,3-di-o-tolylguanidine (trade name “Nocceler DT” supplied by Ouchi Shinko Chemical Industrial Co., Ltd.) as an elastomer-crosslinking coagent; 10 parts by weight of carbon black (trade name “Asahi Carbon #35” supplied by Asahi Carbon Co., Ltd.) as a colorant; and 8 parts by weight of a phenolic age inhibitor (trade name “SUMILIZER GM” supplied by Sumitomo Chemical Co., Ltd.). The materials were charged into a twin-blade compact dispersion kneader (device name “TD-10-20 MDX” supplied by Toshin Co., Ltd., mixing capacity: 10 L), kneaded under the condition of a blade rotation speed of 30 rpm and a temperature of 80° C. for 40 minutes, and yielded a resin composition.

The resin composition for expansion was molded to give an unfoamed resin molded article, this was pulverized to a size of several millimeters, the pulverized product was fed through a constant-volume feeder to a single-screw extruder (device name “φ 40 Single-screw Extruder” supplied by PLA GIKEN CO., LTD., screw diameter: 40 mm in diameter, L/D: 30, screw: a full-flighted screw having a conically tapered root-diameter). While kneading the pulverized product under the condition of a temperature of 80° C., carbon dioxide was injected (introduced) in a gas amount of 4 percent by weight (such an amount as to be 4 parts by weight per 100 parts by weight of the resin composition) to impregnate the resin composition sufficiently with carbon dioxide. The carbon dioxide was fed as a high-pressure carbon dioxide by pressurizing to a fed gas pressure of 28 MPa using a pump. The injected carbon dioxide immediately became a supercritical state because the single-screw extruder had a preset temperature of 80° C.

Next, the resin composition impregnated with carbon dioxide was extruded through a circular die at the extruder nose into the atmosphere, thereby decompressed to the atmospheric pressure, expanded, and yielded a sheet-form foamed structure. This step was a molding-decompression step, in which molding and expansion were simultaneously performed.

The foamed structure was irradiated with an electron beam (acceleration voltage: 250 kV) from one side to a dose on the one side of 200 kGy. The electron beam irradiation allowed the active-energy-ray-curable compound to react to form a crosslinked structure.

After the electron beam irradiation, the resulting article was subjected to a heating treatment by leaving stand at an ambient temperature of 170° C. for one hour. The heating treatment allowed the elastomer-crosslinking agent to react to form a crosslinked structure.

Thus, a foam was obtained as a sheet having a thickness of about 5 mm.

### Example 3

Initially, an acrylic elastomer was prepared from 85 parts by weight of butyl acrylate, 15 parts by weight of acrylonitrile, and 6 parts by weight of acrylic acid. The acrylic elastomer had an acrylic acid content of 5.67 percent by weight, a weight-average molecular weight (molecular weight in terms of a polystyrene standard) of 217×10⁴, and a glass transition temperature of −20° C. Next, materials were prepared as 100 parts by weight of the acrylic elastomer; 30 parts by weight of an ethoxylated bisphenol-A diacrylate (a bifunctional acrylate, trade name “A-BPE30” supplied by Shin-Nakamura Chemical Co., Ltd., glass transition temperature as a homopolymer: 250° C. or higher) as an active-energy-ray-curable compound; 45 parts by weight of trimethylolpropane trimethacrylate (a trifunctional acrylate, trade name “NK Ester TMPT” supplied by Shin-Nakamura Chemical Co., Ltd., glass transition temperature as a homopolymer: 250° C. or higher) as an active-energy-ray-curable compound; 50 parts by weight of magnesium hydroxide (trade name “EP1-A” supplied by Konoshima Chemical Co., Ltd.) as inorganic particles; 2 parts by weight of hexamethylenediamine (trade name “diak No. 1” supplied by E. I. du Pont de Nemours & Co.) as an elastomer-crosslinking agent (thermal crosslinking agent); and 8 parts by weight of a phenolic age inhibitor (trade name “SUMILIZER GM” supplied by Sumitomo Chemical Co., Ltd.). The materials were charged into a twin-blade compact dispersion kneader (device name “TD-10-20 MDX” supplied by Toshin Co., Ltd., mixing capacity: 10 L), kneaded under the condition of a blade rotation speed of 30 rpm and a temperature of 80° C. for 40 minutes, and yielded a resin composition.

Except for using this resin composition for expansion, a foam was obtained by the procedure of Example 1.

### COMPARATIVE EXAMPLE 1

Initially, an acrylic elastomer was prepared from 85 parts by weight of butyl acrylate, 15 parts by weight of acrylonitrile, and 6 parts by weight of acrylic acid. The acrylic elastomer had an acrylic acid content of 5.67 percent by weight, a weight-average molecular weight (molecular weight in terms of a polystyrene standard) of 217×10⁴, and a glass transition temperature of −20° C. Next, materials were prepared as 100 parts by weight of the acrylic elastomer; 75 parts by weight of a multifunctional acrylate mixture (trade name “ARONIX M8530” supplied by Toagosei Co., Ltd.) as active-energy-ray-curable compounds; 50 parts by weight of magnesium hydroxide (trade name “EP1-A” supplied by Konoshima Chemical Co., Ltd.) as inorganic particles; 2 parts by weight of hexamethylenediamine (trade name “diak No. 1” supplied by E. I. du Pont de Nemours & Co.) as an elastomer-crosslinking agent (thermal crosslinking agent); 2 parts by weight of 1,3-di-o-tolylguanidine (trade name “Nocceler DT” supplied by Ouchi Shinko Chemical Industrial Co., Ltd.) as an elastomer-crosslinking coagent; and 8 parts by weight of a phenolic age inhibitor (trade name “SUMILIZER GM” supplied by Sumitomo Chemical Co., Ltd.). The materials were charged into a twin-blade compact dispersion kneader (device name “TD-10-20-MDX” supplied by Toshin Co., Ltd., mixing capacity: 10 L), kneaded under the condition of a blade rotation speed of 30 rpm and a temperature of 80° C. for 40 minutes, and yielded a resin composition.

The resin composition for expansion was molded to give an unfoamed resin molded article, this was pulverized to a size of several millimeters, and the pulverized product was fed through a constant-volume feeder to a single-screw extruder (screw: a full-flighted screw). While kneading the pulverized product under the condition of a temperature of 70° C., carbon dioxide was injected (introduced) in a gas amount of 10 percent by weight (such an amount as to be 10 parts by weight per 100 parts by weight of the resin composition) to impregnate the resin composition sufficiently with carbon dioxide. The carbon dioxide was fed as a high-pressure carbon dioxide by pressurizing to a fed gas pressure of 28 MPa using a pump. The injected carbon dioxide immediately became a supercritical state because the extruder had a preset temperature of 70° C.

Next, the resin composition impregnated with carbon dioxide was extruded through a circular die at the extruder nose into the atmosphere, thereby decompressed to the atmospheric pressure, expanded, and yielded a sheet-form foamed structure. This step was a molding-decompression step, in which molding and expansion were simultaneously performed.

The foamed structure was irradiated with an electron beam (acceleration voltage: 250 kV) on one side to a dose of dose 100 kGy. The electron beam irradiation allowed the active-energy-ray-curable compound to react to form a crosslinked structure.

After the electron beam irradiation, the resulting article was subjected to a heating treatment by leaving stand at an ambient temperature of 170° C. for one hour. The heating treatment allowed the elastomer-crosslinking agent to react to form a crosslinked structure.

Thus, a foam was obtained as a sheet having a thickness of about 5 mm.

### COMPARATIVE EXAMPLE 2

Initially, an acrylic elastomer was prepared from 85 parts by weight of butyl acrylate, 15 parts by weight of acrylonitrile, and 6 parts by weight of acrylic acid. The acrylic elastomer had an acrylic acid content of 5.67 percent by weight, a weight-average molecular weight (molecular weight in terms of a polystyrene standard) of 217×10⁴, and a glass transition temperature of −20° C. Next, materials were prepared as 100 parts by weight of the acrylic elastomer; 75 parts by weight of a multifunctional acrylate mixture (trade name “ARONIX M8530” supplied by Toagosei Co., Ltd.) as active-energy-ray-curable compounds; 50 parts by weight of magnesium hydroxide (trade name “EP1-A” supplied by Konoshima Chemical Co., Ltd.) as inorganic particles; 2 parts by weight of hexamethylenediamine (trade name “diak No. 1” supplied by E. I. du Pont de Nemours & Co.) as an elastomer-crosslinking agent (thermal crosslinking agent); 2 parts by weight of 1,3-di-o-tolylguanidine (trade name “Nocceler DT” supplied by Ouchi Shinko Chemical Industrial Co., Ltd.) as an elastomer-crosslinking coagent; 10 parts by weight of carbon black (trade name “Asahi Carbon #35” supplied by Asahi Carbon Co., Ltd.) as a colorant; and 8 parts by weight of a phenolic age inhibitor (trade name “SUMILIZER GM” supplied by Sumitomo Chemical Co., Ltd.). The materials were charged into a twin-blade compact dispersion kneader (device name “TD-10-20 MDX” supplied by Toshin Co., Ltd., mixing capacity: 10 L), kneaded under the condition of a blade rotation speed of 30 rpm and a temperature of 80° C. for 40 minutes, and yielded a resin composition.

The resin composition for expansion was molded to give an unfoamed resin molded article, this was pulverized to a size of several millimeters, the pulverized product was fed through a constant-volume feeder to an extruder. The extruder was a tandem extruder including a twin-screw/single-screw extruder (screw: a tapered screw) connected to a side of a resin feeding unit of a single-screw extruder (screw: a full-flighted screw). While kneading the pulverized product under the condition of a temperature of 70° C., carbon dioxide was injected (introduced) in a gas amount of 10 percent by weight (such an amount as to be 10 parts by weight per 100 parts by weight of the resin composition) to impregnate the resin composition sufficiently with carbon dioxide. The carbon dioxide was fed as a high-pressure carbon dioxide by pressurizing to a fed gas pressure of 28 MPa using a pump. The injected carbon dioxide immediately became a supercritical state because the extruder had a preset temperature of 70° C.

Next, the resin composition impregnated with carbon dioxide was extruded through a circular die at the extruder nose into the atmosphere, thereby decompressed to the atmospheric pressure, expanded, and yielded a sheet-form foamed structure. This step was a molding-decompression step, in which molding and expansion were simultaneously performed.

The foamed structure was irradiated with an electron beam (acceleration voltage: 250 kV) on both sides once per one side to a dose of 100 kGy per one side. The electron beam irradiation allowed the active-energy-ray-curable compound to react to form a crosslinked structure.

After the electron beam irradiation, the resulting article was subjected to a heating treatment by leaving stand at an ambient temperature of 170° C. for one hour. The heating treatment allowed the elastomer-crosslinking agent to react to form a crosslinked structure.

Thus, a foam was obtained as a sheet having a thickness of about 5 mm.

### COMPARATIVE EXAMPLE 3

Initially, an acrylic elastomer was prepared from 85 parts by weight of butyl acrylate, 15 parts by weight of acrylonitrile, and 6 parts by weight of acrylic acid. The acrylic elastomer had an acrylic acid content of 5.67 percent by weight, a weight-average molecular weight (molecular weight in terms of a polystyrene standard) of 217×10⁴, and a glass transition temperature of −20° C. Next, materials were prepared as 100 parts by weight of the acrylic elastomer; 75 parts by weight of a polypropylene glycol diacrylate (a bifunctional acrylate, trade name “ARONIX M270” supplied by Toagosei Co., Ltd., glass transition temperature: −32° C.) as an active-energy-ray-curable compound; 50 parts by weight of magnesium hydroxide (trade name “EP1-A” supplied by Konoshima Chemical Co., Ltd.) as inorganic particles; 2 parts by weight of hexamethylenediamine (trade name “diak No. 1” supplied by E. I. du Pont de Nemours & Co.) as an elastomer-crosslinking agent (thermal crosslinking agent); 2 parts by weight of 1,3-di-o-tolylguanidine (trade name “Nocceler DT” supplied by Ouchi Shinko Chemical Industrial Co., Ltd.) as an elastomer-crosslinking coagent; and 8 parts by weight of a phenolic age inhibitor (trade name “SUMILIZER GM” supplied by Sumitomo Chemical Co., Ltd.). The materials were charged into a twin-blade compact dispersion kneader (device name “TD-10-20 MDX” supplied by Toshin Co., Ltd., mixing capacity: 10 L), kneaded under the condition of a blade rotation speed of 30 rpm and a temperature of 80° C. for 40 minutes, and yielded a resin composition.

The resin composition for expansion was molded to give an unfoamed resin molded article, this was pulverized to a size of several millimeters, the pulverized product was fed through a constant-volume feeder to a single-screw extruder (device name “φ 40 Single-screw Extruder” supplied by PLA GIKEN CO., LTD., screw diameter: 40 mm in diameter, L/D: 30, screw: a full-flighted screw having a conically tapered root-diameter). While kneading the pulverized product under the condition of a temperature of 80° C., carbon dioxide was injected (introduced) in a gas amount of 5 percent by weight (such an amount as to be 5 parts by weight per 100 parts by weight of the resin composition) to impregnate the resin composition sufficiently with carbon dioxide. The carbon dioxide was fed as a high-pressure carbon dioxide by pressurizing to a fed gas pressure of 28 MPa using a pump. The injected carbon dioxide immediately became a supercritical state because the extruder had a preset temperature of 80° C.

Next, the resin composition impregnated with carbon dioxide was extruded through a circular die at the extruder nose into the atmosphere, thereby decompressed to the atmospheric pressure, expanded, and yielded a sheet-form foamed structure. This step was a molding-decompression step, in which molding and expansion were simultaneously performed.

The foamed structure was irradiated with an electron beam (acceleration voltage: 250 kV) on both sides once per one side to a dose of 100 kGy per one side. The electron beam irradiation allowed the active-energy-ray-curable compound to react to form a crosslinked structure.

The resulting article, however shrank significantly from the initial shape immediately after expansion.

After the electron beam irradiation, the resulting article was subjected to a heating treatment by leaving stand at an ambient temperature of 170° C. for one hour. The heating treatment allowed the elastomer-crosslinking agent to react to form a crosslinked structure. Thus, a foam was obtained as a sheet having a thickness of roughly about 5 mm. The foam, however, underwent significant shrinkage, and an accurate thickness and an after-mentioned strain recovery rate thereof were not determinable.

Evaluations

On the examples and the comparative examples, a glass transition temperature, a storage elastic modulus at 20° C., an expansion ratio, and a strain recovery rate (80° C., 50% compression set) were determined. The results are indicated in Table 1.

Glass Transition Temperature and Storage Elastic Modulus at 20° C.

Each of the resin compositions prepared to form the resin foams was molded into a sheet having a thickness of 0.3 mm to give a resin molded article. The resin molded article was irradiated with an electron beam (acceleration voltage: 250 kV) on both sides once per one side to a dose of 200 kGy, and left stand at an ambient temperature of 170° C. for one hour to give an unfoamed measurement sample.

The unfoamed measurement sample was subjected to a dynamic viscoelastic measurement with a dynamic viscoelastic measurement system (ARES supplied by TA Instruments) in a tensile test mode using a 5-mm jig for tensile test, at a frequency of 1 Hz, at temperatures in the range of from −50° C. to 200° C., and at a rate of temperature rise of 5° C./minute.

Based on the dynamic viscoelastic measurement, a storage elastic modulus (E′) at 20° C. was determined. Also based on the dynamic viscoelastic measurement, a loss elastic modulus E″ was determined, whose peak temperature was defined as the glass transition temperature.

Expansion Ratio

Each of the resin compositions was molded to give an unfoamed resin molded article. A specific gravity of the unfoamed resin molded article was measured using an electronic densimeter (trade name “MD-200S” supplied by Alfa Mirage Co., Ltd.), from which a density of the unfoamed resin molded article was determined and defined as a “density before expansion”. The measurement was performed after storing the unfoamed resin molded article at room temperature for 24 hours after its preparation.

Next, a specific gravity of each of the foams was measured using an electronic densimeter (trade name “MD-200S” supplied by Alfa Mirage Co., Ltd.), from which a density of the sample foam was determined and defined as a “density after expansion”. The measurement was performed after storing the sample foam at room temperature for 24 hours after its production.

The expansion ratio was determined according to an expression specified as follows:

Expansion ratio(time)=[(Density before expansion)/(Density after expansion)]

Strain Recovery Rate (80° C., 50% Compression Set)

Each of the foams was cut to give a 25-mm square specimen, whose thickness was accurately measured. The thickness of the specimen at this time was defined as a thickness “a”. The specimen was compressed to a thickness “b” 50% of the thickness “a” using a spacer having a thickness “b” half the thickness of the specimen, and stored in this state at 80° C. for 24 hours. Twenty-four (24) hours later, the specimen was returned to room temperature while being held under compression, followed by decompression. The thickness of the specimen was accurately measured 24 hours after the decompression.

The thickness of the specimen in this state was defined as a thickness “c”. The ratio of the recovered distance to the compressed distance was defined as a strain recovery rate (80° C., 50% compression set) expressed as follows:

Strain recovery rate(80° C.,50% compression set)[%]=(c−b)/(a−b)×100

TABLE 1

| | Glass | Storage | | |
|---|---|---|---|---|
| | transition | elastic | Expansion | Strain |
| | temperature | modulus | ratio | recovery |
| | [° C.] | E′ at 20° C. | [time] | rate [%] |
| Example 1 | −7 | 2.04 × 10⁷ | 15.8 | 91 |
| Example 2 | −7 | 7.28 × 10⁷ | 21.0 | 90 |
| Example 3 | −8 | 1.32 × 10⁸ | 14.5 | 90 |
| Comparative | higher than 80 | 2.81 × 10⁸ | 14.3 | 2 |
| Example 1 | | | | |
| Comparative | higher than 80 | 2.81 × 10⁸ | 52.7 | 0 |
| Example 2 | | | | |
| Comparative | −12 | 8.31 × 10⁶ | 2.8 | — |
| Example 3 | | | | |

The foam according to Comparative Example 3 underwent significant shrinkage, whose accurate thickness could not be calculated. This impeded the determination of the strain recovery rate.

### INDUSTRIAL APPLICABILITY

Resin foams according to embodiments of the present invention excel in cushioning properties and strain recovery (compression set recovery) and are usable typically as internal insulators in electronic devices, cushioning materials, sound insulators, heat insulators, food packaging materials, clothing materials, and building materials.

### REFERENCE SIGNS LIST

1 resin foam
2 surface layer

1. A resin foam obtained from a resin composition comprising an elastomer and an active-energy-ray-curable compound, wherein the resin composition gives an unfoamed measurement sample having a glass transition temperature of 30° C. or lower and a storage elastic modulus (E′) at 20° C. of 1.0×10⁷ Pa or more, each as determined by a dynamic viscoelastic measurement.

2. The resin foam according to claim 1, wherein: the elastomer has a glass transition temperature of 30° C. or lower; and the resin composition, when cured under a specific curing condition, has a glass transition temperature of 30° C. or lower, the curing condition expressed as follows:
Curing condition: the resin composition is cured by molding the resin composition into a sheet having a thickness of 0.3 mm to give a resin molded article; irradiating the resin molded article with an electron beam at an acceleration voltage of 250 kV to a dose of 200 kGy; and leaving the irradiated article stand at an ambient temperature of 170° C. for one hour.

3. The resin foam according to claim 1, which is obtained by subjecting the resin composition to expansion molding to give a foamed structure; and irradiating the foamed structure with an active energy ray.

4. The resin foam according to claim 3, wherein the expansion molding of the resin composition is performed by impregnating the resin composition with a blowing agent and decompressing the impregnated resin composition to expand the resin composition.

5. The resin foam according to claim 3, wherein the expansion molding of the resin composition employs a blowing agent; and carbon dioxide or nitrogen is used as the blowing agent.

6. The resin foam according to claim 3, wherein the expansion molding of the resin composition employs a blowing agent; and liquefied carbon dioxide is used as the blowing agent.

7. The resin foam according to claim 3, wherein the expansion molding of the resin composition employs a blowing agent; and carbon dioxide in a supercritical state is used as the blowing agent.

8. The resin foam according to claim 1, which has a strain recovery rate (80° C., 50% compression set) of 40% or more.

9. The resin foam according to claim 1, which has an expansion ratio of 5 times or more.

10. A process for producing a resin foam, the process comprising the steps of:
(1) subjecting a resin composition to expansion molding to form a foamed structure, the resin composition comprising an elastomer and an active-energy-ray-curable compound; and
(2) irradiating the foamed structure with an active energy ray,
wherein the process further comprises the step of preparing, as the resin composition, a resin composition that gives an unfoamed measurement sample having a glass transition temperature of 30° C. or lower and a storage elastic modulus (E′) at 20° C. of 1.0×10⁷ Pa or more, each as determined by a dynamic viscoelastic measurement.
